(19) United States
(12) Patent Application Publication
(10) Pub. No.: US 2017/0021464 A1
(43) Pub. Date: Jan. 26, 2017

(54) WORKPIECE ADAPTER APPARATUS, COMBINATION OF WORKPIECE HOLDING APPARATUS AND WORKPIECE ADAPTER APPARATUS, AND MACHINE TOOL

(71) Applicant: MAG IAS GmbH, Eislingen (DE)

(72) Inventors: Tilmann Traub, Heiningen (DE); Hans-Dieter Buehrle, Merklingen (DE)

(21) Appl. No.: 15/046,775

(22) Filed: Feb. 18, 2016

Related U.S. Application Data
(63) Continuation of application No. PCT/EP2014/067411, filed on Aug. 14, 2014.

(30) Foreign Application Priority Data
Sep. 6, 2013 (DE) 10 2013 109 780

(51) Int. Cl. B23Q 3/10

(52) U.S. Cl. CPC B23Q 3/105; B23Q 3/103

(57) ABSTRACT

The invention relates to a workpiece adapter apparatus for a machine tool to which at least one workpiece can be fixed and which can be fixed to a workpiece holding apparatus of the machine tool, comprising a holding body having a first side on which is arranged a first fixing device for the at least one workpiece and having a second side, opposite the first side, on which is arranged a second fixing device for fixing the holding body to the workpiece holding apparatus.

This application is a continuation of international application number PCT/EP2014/067411 filed on Aug. 14, 2014 and claims the benefit of German application number 10 2013 109 780.4 filed on Sep. 6, 2013, which are incorporated herein by reference in their entirety and for all purposes.

### BACKGROUND OF THE INVENTION

The invention relates to a workpiece adapter apparatus for a machine tool which is capable of having at least one workpiece fixed thereto and which is capable of being fixed to a workpiece holding apparatus of the machine tool.

The invention further relates to a combination of a workpiece holding apparatus and a workpiece adapter apparatus.

Furthermore, the invention relates to a machine tool.

EP 1 260 304 A1 discloses a workpiece holder comprising a workpiece carrier and a workpiece carrier plate (adapter), wherein the workpiece carrier plate is provided with devices for fixing a workpiece in a predetermined position relative to the workpiece carrier plate, wherein the workpiece holder is provided with contact faces and the workpiece carrier plate is provided with counter-faces in contact against the contact faces, in such a way that the workpiece carrier plate has an accurately predetermined position in a first, a second and a third coordinate direction, and wherein clamping devices for clamping the workpiece carrier plate relative to the workpiece carrier in the first, second and third coordinate directions are provided.

DE 20 2004 014 436 U1 discloses a clamping system comprising a pallet changer capable of being attached to a machine bed, the pallet changer comprising at least one clamping device, and a workpiece-carrying pallet, which pallet is capable of being fixed to the clamping device of the pallet changer. Additional support means are provided at a position spaced apart from the clamping area of the clamping device in order to support the pallet on the pallet changer and/or on the machine bed and thus transfer working forces and/or weight forces into the machine bed, thereby relieving the clamping area.

U.S. Pat. No. 5,788,225 discloses an apparatus that serves to hold a workpiece.

DD 85 699 discloses a device for unclamping workpieces clamped to machine tool tables or pallet-type workpiece carriers.

DE 100 59 193 C1 discloses a work-performing system comprising movable workpiece carrier and workpiece clamping modules.

### SUMMARY OF THE INVENTION

In accordance with an embodiment of the invention, a workpiece adapter apparatus is provided that permits short workpiece loading times and workpiece unloading times in a machine tool, while being simple in construction.

In accordance with an embodiment of the invention, a holding body is provided having a first side on which is arranged a first fixing device for the at least one workpiece and having a second side, opposite the first side, on which is arranged a second fixing device for fixing the holding body to the workpiece holding apparatus.

A workpiece adapter apparatus is used in instances where a workpiece is not to be fixed to the workpiece holding apparatus of the machine tool directly. This can reduce loading and unloading times. In particular, with this arrangement, a workpiece is fixed to the workpiece adapter apparatus outside the machine tool and the combination of workpiece adapter apparatus and workpiece is then fixed to the workpiece holding apparatus of the machine tool. For the unloading operation, the combination of workpiece adapter apparatus and workpiece is removed from the machine tool.

In the solution in accordance with the invention, the first fixing device and the second fixing device are arranged on different sides of the holding body, whereby a separation exists therebetween. Thus, when work is performed on a workpiece, the second fixing device will not interfere with the working operation and, in particular, will not protrude into a workspace area relevant for the workpiece working operation. This renders the workpiece accessible from five sides when it is being worked on.

A corresponding workpiece adapter apparatus can be fixed to and released from the workpiece holding apparatus in a simple manner. In particular, its placement can be effected from one direction and its release can be effected in the counter-direction thereto. The need for threading operations or the like is then eliminated. This in turn enables quick loading times and quick unloading times to be achieved.

The corresponding workpiece adapter apparatus can be configured for simple construction.

In particular, the holding body is at least approximately cuboid in shape. This results in a configuration that is simple in structure.

In an exemplary embodiment, the holding body has a holding plate on which the first fixing device is arranged. This results in a configuration that is simple in structure. By way of the holding plate, the first side can, in a sense, be separated from the second side.

Provision may be made for the holding plate to be of at least approximately planar configuration on the first side. In this way, a first fixing device can be easily positioned on the first side and a workpiece can be easily fixed.

In particular, the holding plate covers the second fixing device towards the first side. As a result, the second fixing device does not project into a workspace when performing working operations on a workpiece. As a result, good accessibility by the working tools to the workpiece is achieved.

It is further advantageous for the holding plate to have a wall arranged thereon on the side facing away from the first side, which wall is in particular located at the edge of the holding plate and in particular extends around the perimeter thereof. By way of said wall, the second fixing device can also be covered laterally. The wall can have engagement devices arranged thereon to provide for handling the workpiece adapter apparatus, for example for purposes of its transport etc. By way of example, an end face of the wall can be configured as a guide surface for, for example, interlinking conveyors.

The workpiece adapter apparatus is configured with simple structure if the second fixing device is arranged on the holding plate and/or on the wall. This makes for a stiff construction.

In particular, the wall covers the second fixing device laterally. As a result, corresponding fixing elements of the workpiece holding apparatus as well are protected for workpiece working operations.

In particular, a recessed space is formed between a rear side of the holding plate, facing away from the first side, and the wall, in particular wherein an open side of the recessed space is located on the second side of the holding body. For example, receptacles and the like can be arranged in the recessed space.

It is advantageous for an end face of the wall to be configured as a guide surface and, for example, to be configured as a rolling surface. This provides a simple way of realizing interlinking conveyors. In particular, the end face is configured as a guide surface in a first direction and in a second direction that is transverse to the first direction. This provides a way for the workpiece adapter apparatus to be guided and transported in different orientations, for example on roller conveyors.

Advantageously, the second fixing device has receptacles for entry elements and/or engaging elements of the workpiece holding apparatus. This provides a simple and quick way of loading and unloading a workpiece adapter apparatus to and from the workpiece holding apparatus.

It is advantageous for receptacles of the second fixing device to be arranged in corner regions of the holding body. This provides a simple way of achieving a fixing action that can absorb high forces.

In particular, at least four receptacles are provided, wherein at least two receptacles are provided for centering and at least two receptacles are provided for clamping. This provides a simple and quick way of realizing loading or unloading operations.

For example, at least one receptacle provided for centering is arranged between receptacles provided for clamping. This results in a construction which is simple in structure, yet has high mechanical stiffness.

In an exemplary embodiment, the holding body has arranged thereon retention bars of the second fixing device for engagement therein of respective pivoting clamps of the workpiece holding apparatus. This provides a simple way of accomplishing a fixing (clamping) action.

In particular, at least two retention bars are provided. In one concrete exemplary embodiment, three retention bars are provided; and in another concrete exemplary embodiment, four retention bars are provided.

Advantageously, a retention bar has a blocking face which is spaced apart from a rear side, opposite the first side, of a holding plate. Formed between the blocking face and the rear side is an interspace into which an engaging element of a fixing element, for example, of a pivoting clamp, can enter in order to provide for fixing.

It is further advantageous for the holding body to have arranged thereon at least two centering recesses of the second fixing device for a respective centering element of the workpiece holding apparatus. This provides a simple way of accomplishing defined positioning and centering of the workpiece adapter apparatus on the workpiece holding apparatus. In particular, it is possible for the workpiece adapter apparatus to be inserted on and released from the workpiece holding apparatus in one single direction and counter-direction respectively.

For example, the at least one centering recess can be configured for receiving a bolt or in the form of a sleeve for a cone element.

In an exemplary embodiment, a transmitter or a sensor or an identification device such as a data chip is arranged on the second side of the holding body. A cooperating mate of, for example, a sensor/transmitter device can be arranged on the workpiece holding apparatus.

Provision may also be made for the holding body to comprise at least one through-recess via which communication between the second side and the first side is established. For example, such a recess can be used to fix the workpiece by the first fixing device to the holding body from the second side. Furthermore, one or more through-recesses may be provided via which the workpiece is accessible from the second side in order to perform working operations or test operations on the workpiece. For example, this provides a way of performing tightness tests on the workpiece. Accessing the first side from the second side does not interfere with the access of a working tool of the machine tool to the workpiece.

In an exemplary embodiment, the first fixing device has support elements for the at least one workpiece. The workpiece can be placed on the support elements and can then be fixed thereby.

In particular, the first fixing device has a form-locking device for form-locking fixing of the at least one workpiece to the holding body. In particular, the workpiece can be attached to the holding body by use of screws.

In accordance with an embodiment of the invention, there is provided a combination of a workpiece holding apparatus and a workpiece adapter apparatus for a machine tool, said combination comprising a workpiece holding apparatus fixedly arranged on the machine tool and at least one workpiece adapter apparatus constructed in accordance with the invention, wherein the workpiece adapter apparatus is releasably fixed or fixable to the workpiece holding apparatus via fixing elements of the workpiece holding apparatus.

This combination has the advantages that have already been described in connection with the workpiece adapter apparatus constructed in accordance with the invention.

In particular, the workpiece holding apparatus comprises as the fixing element a plurality of pivoting clamps and comprises, in particular, at least two pivoting clamps. In particular, these allow for a clamping action to be achieved in a simple manner.

Furthermore, it is advantageous for the workpiece holding apparatus to comprise as the fixing element at least two centering elements for entering a respective receptacle of the workpiece adapter apparatus. The at least two centering elements serve to position the workpiece adapter apparatus at the workpiece holding apparatus. The use of a plurality of centering elements enables in particular a placement operation to be realized in one single direction and a release operation to be realized in one single direction, namely in the corresponding counter-direction.

A centering element is for example a centering bolt or a centering cone.

In an embodiment, the workpiece holding apparatus comprises a sensor, wherein a cooperating mate, such as a data chip, is arranged on the workpiece adapter apparatus. This allows, for example, identification data to be read at the machine tool.

It is particularly advantageous if, when the workpiece adapter apparatus is fixed to the workpiece holding apparatus, the workpiece adapter apparatus covers fixing elements of the workpiece holding apparatus, and in particular covers all of the fixing elements of the workpiece holding apparatus, towards the first side. As a result, five-sided access of a working tool to a workpiece that is being held on the workpiece adapter apparatus can be attained.

In accordance with an embodiment of the invention, there is provided a machine tool, said machine tool comprising a combination of a workpiece holding apparatus and a workpiece adapter apparatus constructed in accordance with the invention.

The following description of preferred embodiments serves in conjunction with the drawings to explain the invention in greater detail.

### BRIEF DESCRIPTION OF THE DRAWINGS

FIG. 1 is a perspective partial view of a machine tool including a workpiece holding apparatus and a workpiece adapter apparatus fixed thereto;

FIG. 2 is a perspective view of the workpiece holding apparatus of FIG. 1 with the workpiece adapter apparatus removed;

FIG. 3 is a sectional view of the combination of workpiece holding apparatus and workpiece adapter apparatus of FIG. 1, illustrating a non-fixing position of fixing elements of the workpiece holding apparatus;

FIG. 4 is a representation similar to FIG. 3 but shown in perspective view and showing a fixing position of fixing elements;

FIG. 5 is a perspective view of an exemplary embodiment of a workpiece adapter apparatus, indicating by dotted representation a workpiece fixed in place thereto;

FIG. 6 is a perspective view of an exemplary embodiment of a workpiece adapter apparatus;

FIG. 7 is a bottom plan view of the workpiece adapter apparatus of FIG. 6;

FIG. 8 is a side view of the workpiece adapter apparatus of FIG. 6;

FIG. 9 is a sectional view taken along the direction of line-9-9 in FIG. 7;

FIG. 10 is a perspective view of another exemplary embodiment of a workpiece adapter apparatus;

FIG. 11 is a bottom plan view of the workpiece adapter apparatus of FIG. 10;

FIG. 12 is the same view as FIG. 11 but with a dotted indication of a workpiece fixed in place;

FIG. 13 is a front view of the workpiece adapter apparatus of FIG. 10, showing a dotted indication of a workpiece fixed in placed thereto;

FIG. 14 is a sectional view taken along line 14-14 of FIG. 11; and

FIG. 15 is an exemplary embodiment of a workpiece shown in a sectional view adapted to the sectional view of FIG. 14.

### DETAILED DESCRIPTION

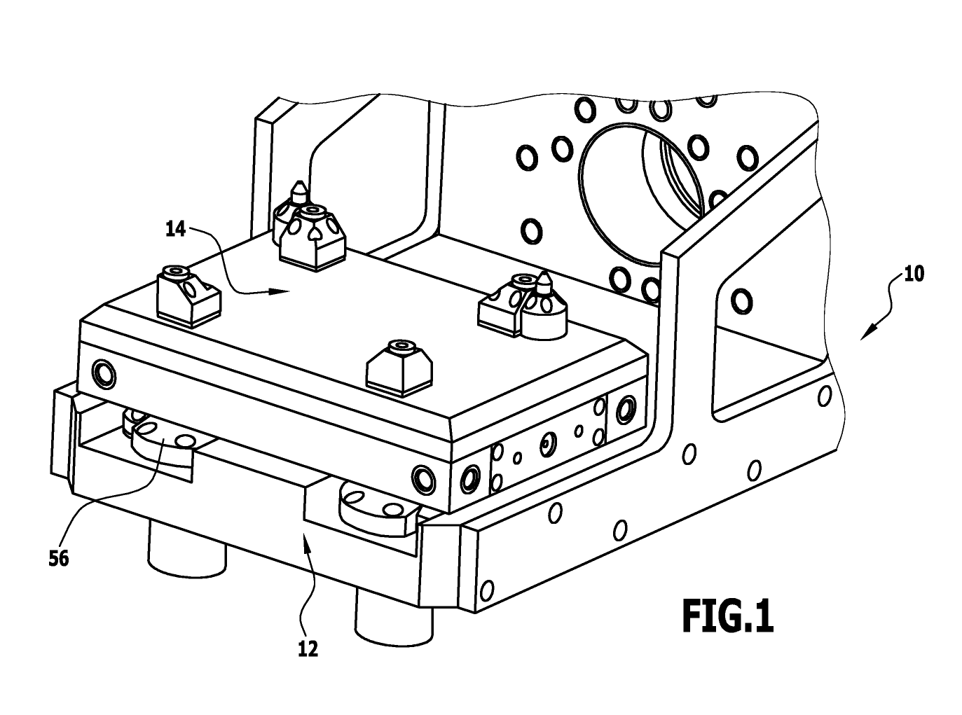

An exemplary embodiment of a machine tool, shown in FIG. 1 in a partial view and designated therein by 10, comprises a workpiece holding apparatus 12. The workpiece holding apparatus 12 (FIGS. 1 to 4) serves to hold one or more workpieces in place while work is performed on the workpiece(s). The machine tool comprises a tool holding device (not shown in the drawings) which, when work is performed on the workpiece(s), holds one or more tools that engage the one or more workpieces.

The workpiece holding apparatus 12 as a whole is arranged on a base of the machine tool 10. The workpiece holding apparatus 12 can be movable or have a capability for translational movement and/or a capability for rotational movement, or it may be arranged immovably relative to the base of the machine tool 10.

In principle, the workpiece holding apparatus 12 can be arranged on the machine tool 10 in a releasable manner in order to allow it to be replaced.

There is provided (at least) one workpiece adapter apparatus 14 which serves to hold the at least one workpiece when it is worked upon by the machine tool 10. The workpiece adapter apparatus 14 has one or more workpieces fixed thereto, wherein the workpiece adapter apparatus 14 itself is fixed to the workpiece holding apparatus 12 when performing work on the workpiece(s).

The workpiece adapter apparatus 14 is capable of being released from the workpiece holding apparatus 12. In particular, this allows a workpiece that is to be worked on to be fixed to a corresponding workpiece adapter apparatus 14 outside of the machine tool 10 or allows a workpiece that has been worked on to be released from the corresponding workpiece adapter apparatus 14 outside of the machine tool 10.

To effect working of a workpiece, the combination of workpiece adapter apparatus 14 and workpiece fixed thereto is positioned, and fixed in position, on the workpiece holding apparatus 12; and after the working operation is performed, the combination of workpiece adapter apparatus and worked workpiece fixed thereto is released from the workpiece holding apparatus 12 and is in particular moved out of a workspace of the machine tool 10.

The machine tool 10 is loaded with the combination of workpiece adapter apparatus 14 and workpiece fixed thereto to effect working of the workpiece, and unloading is effected by releasing the workpiece adapter apparatus 14 onto a workpiece holding apparatus 12 with the worked workpiece fixed to the workpiece adapter apparatus 14.

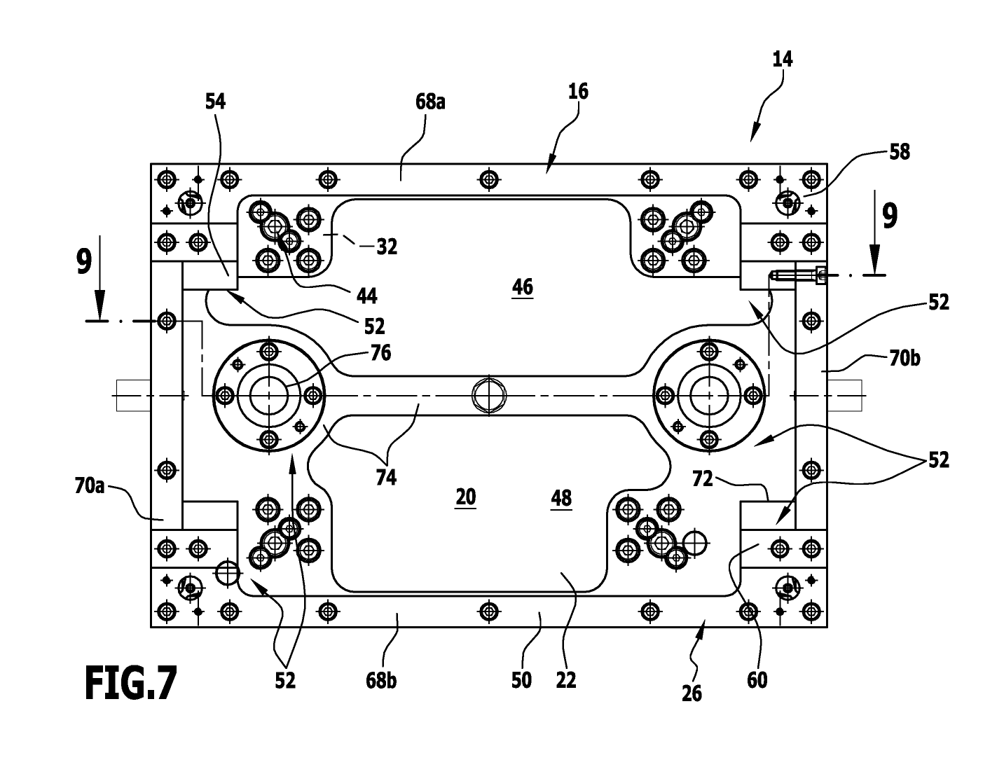

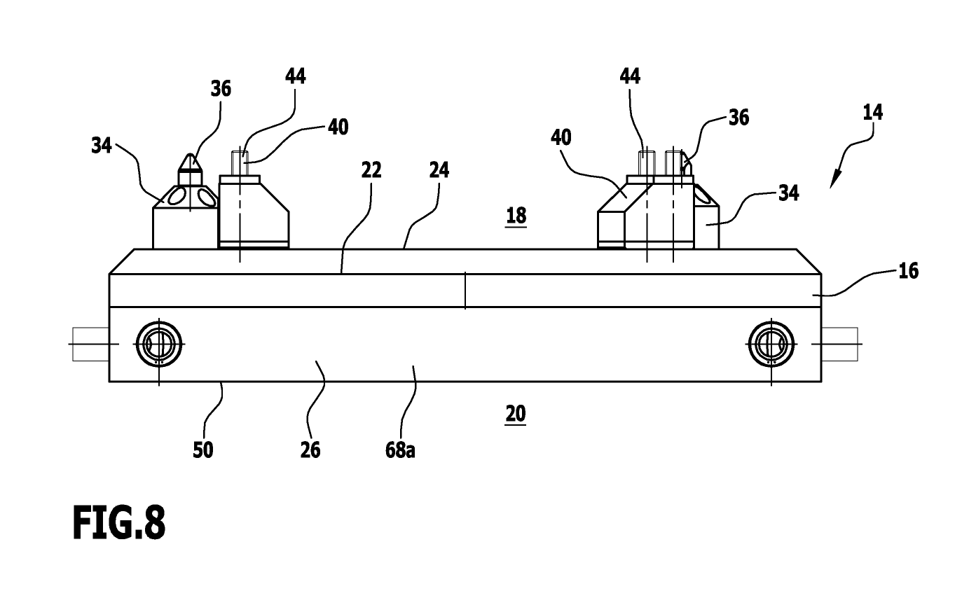

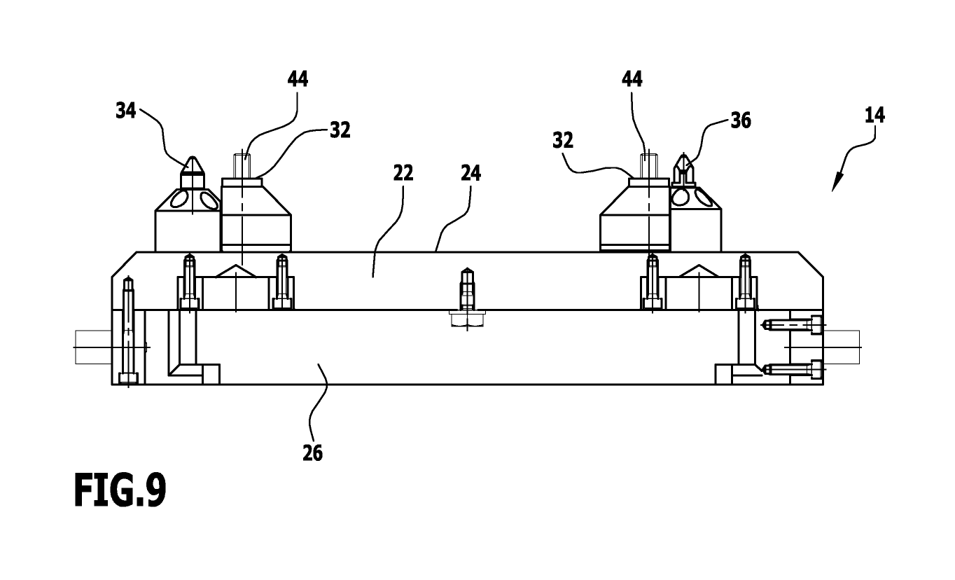

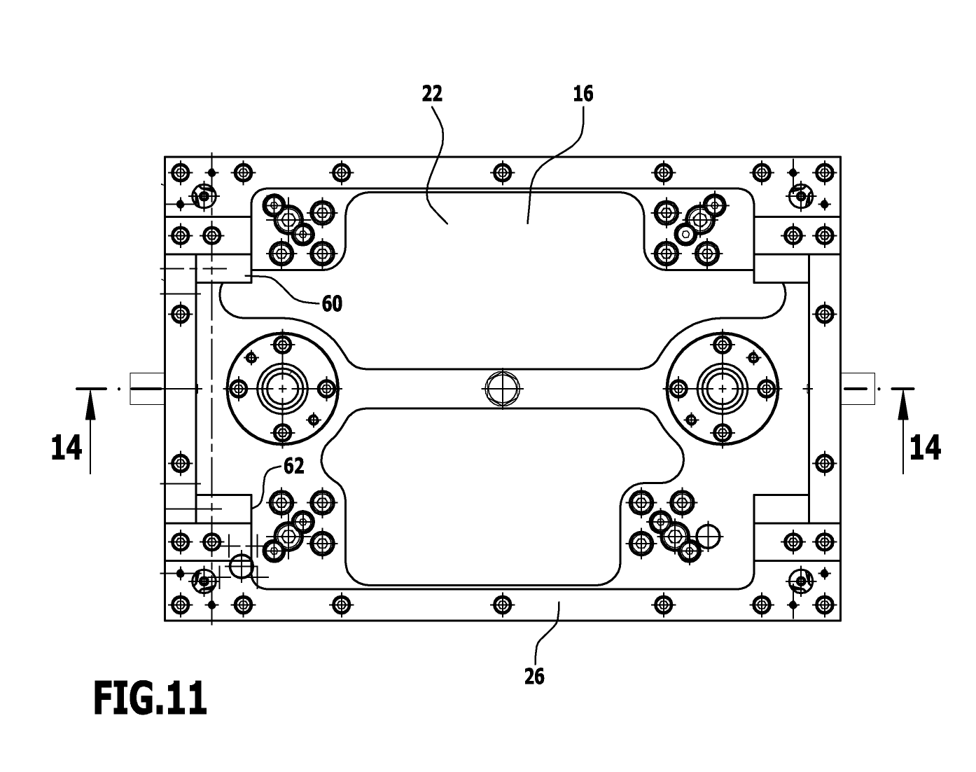

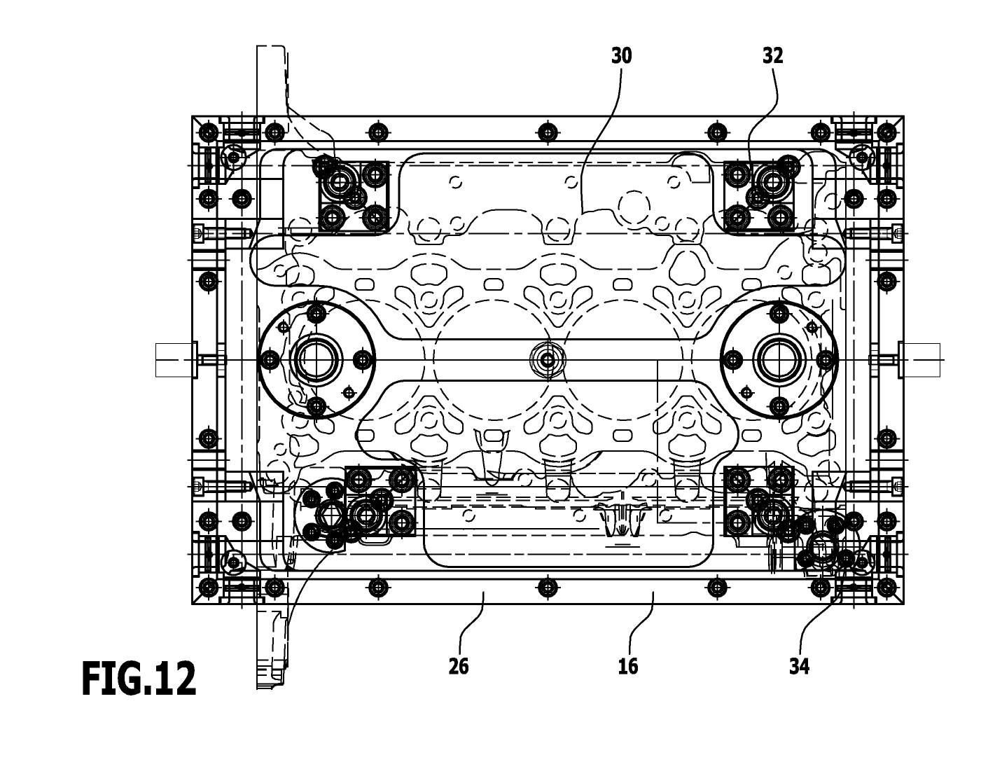

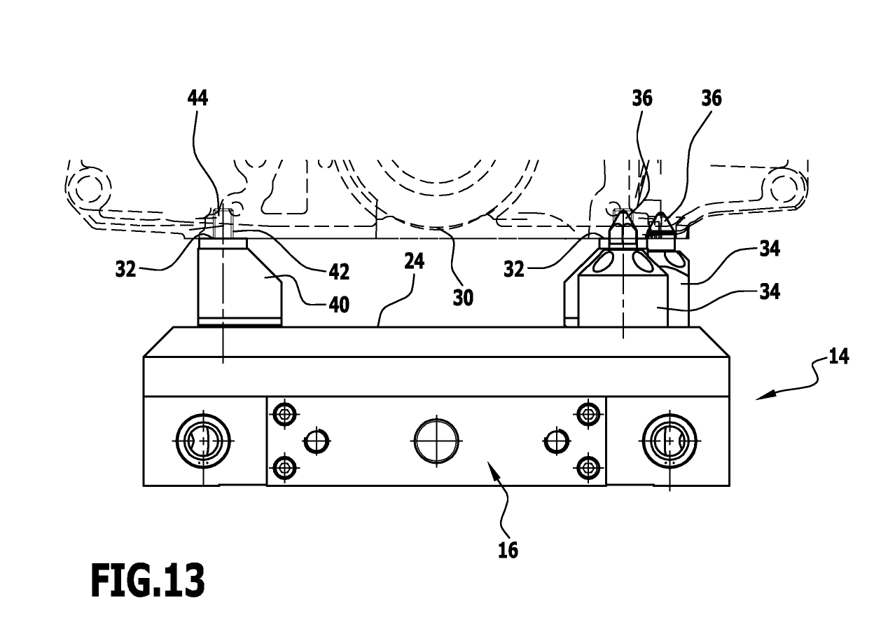

The workpiece adapter apparatus 14 comprises a holding body 16 (FIGS. 7 to 14 in particular) having a first side 18 and a second side 20 opposite the first side. The holding body 16 is at least approximately cuboid in shape.

The holding body 16 comprises a holding plate 22. The holding plate 22 has an at least approximately planar surface 24 on the first side 18.

Arranged on the holding plate 22 and extending therefrom in a direction towards the second side 20 is a wall 26. The wall 26 is formed at the edge of the holding plate 22 and extends around the perimeter thereof.

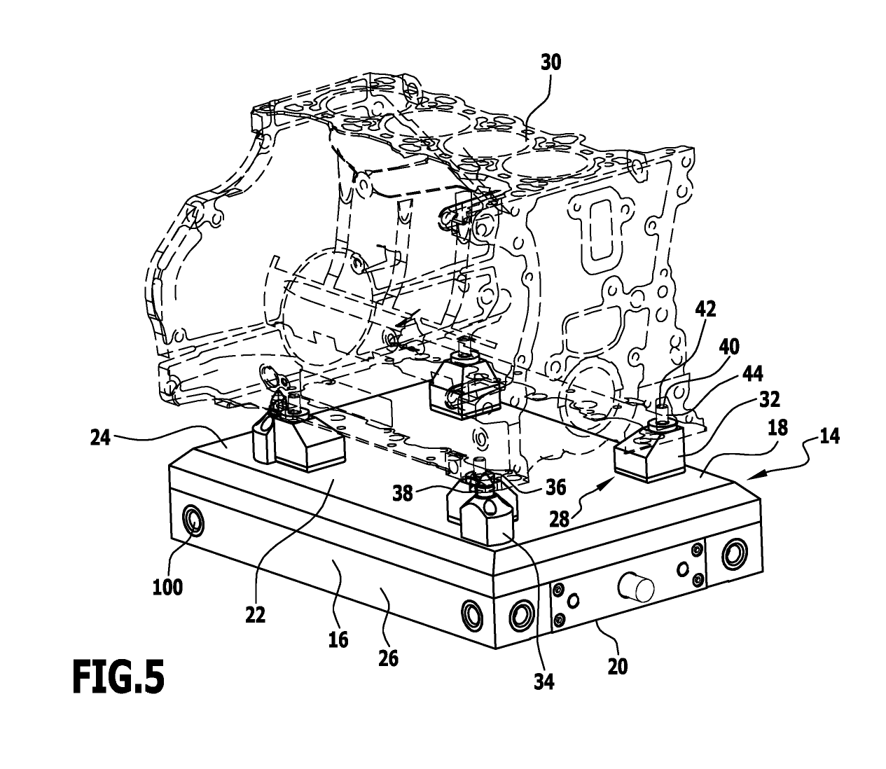

On the first side 18, the holding plate 22 has arranged thereon a first fixing device 28 via which a workpiece 30 is capable of being fixed to the workpiece adapter apparatus 14. In the figures, an engine block is shown as the workpiece 30, indicated by a dotted representation (cf. for example FIG. 5).

In an exemplary embodiment, the first fixing device 28 comprises support elements 32 arranged at vertices of a rectangle. Said support elements are capable of supporting the workpiece.

Furthermore, centering elements 34 are provided. In an exemplary embodiment, two centering elements 34 are provided. A centering element 34 is arranged at or near a support element 32.

The centering elements 34 have centering pins 36 which are capable of being entered into corresponding recesses 38 of the workpiece 30.

Arranged on the support elements 32 are form-locking devices 40. In particular, the workpiece 30 has formed thereon internal threads 42 in which corresponding form-locking elements 44 of said form-locking devices 40 can engage.

By the support elements 32, the workpiece 30 is held in spaced relation to the holding plate 22, i.e. in spaced relation to the planar surface 24 thereof on the first side 18.

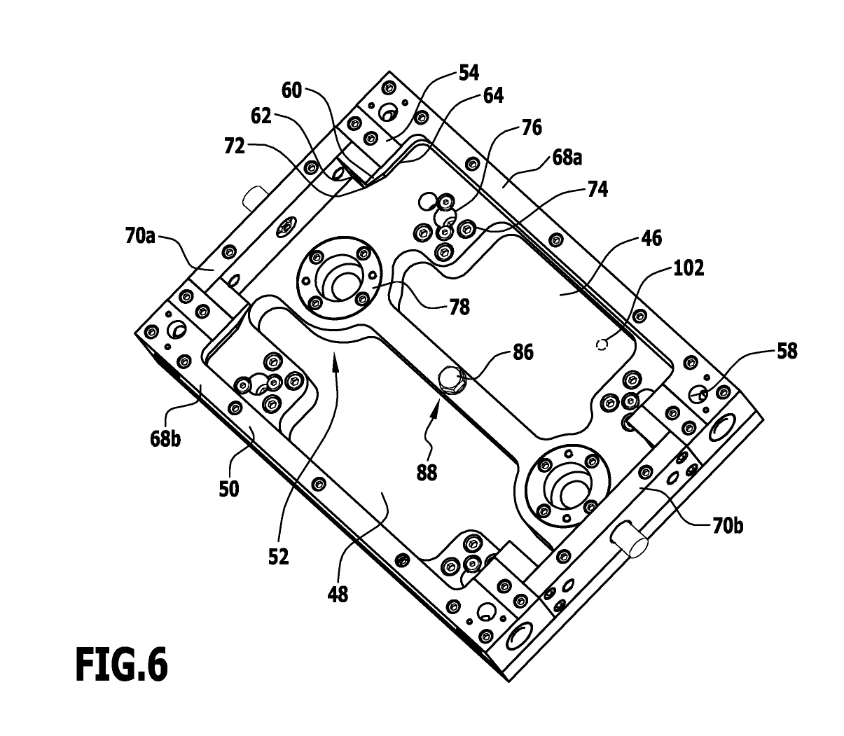

The holding plate 22 has a rear side 46 opposite the first side 18 (cf. for example FIGS. 6 and 7). Formed between the wall 26 and the rear side 46 is a recessed space 48. The recessed space 48 is open towards the second side 20.

The wall 26 presents an end face 50 towards the second side 20. Via the end face 50, the workpiece adapter apparatus 14 is capable of being placed on a support. An envelope of the end face 50 is in particular a plane.

In an exemplary embodiment, the end face 50 is configured with a corresponding end surface formed as a guide surface, such as a rolling surface for a roller conveyor. This provides a simple way of implementing interlinking conveyors.

On the second side 20, the holding body 16 has arranged thereon a second fixing device 52 via which the holding body 16 and therefore the workpiece adapter apparatus 14 can be releasably fixed to the workpiece holding apparatus 12 of the machine tool 10.

The second fixing device comprises receptacles 54 for pivoting clamps 56 (FIGS. 1 to 4) of the workpiece holding apparatus 12. The receptacles 54 are arranged in corner regions 58 of the holding body 16. In one exemplary embodiment, three receptacles 54 are provided. In the exemplary embodiment as illustrated herein, four receptacles 54 are provided.

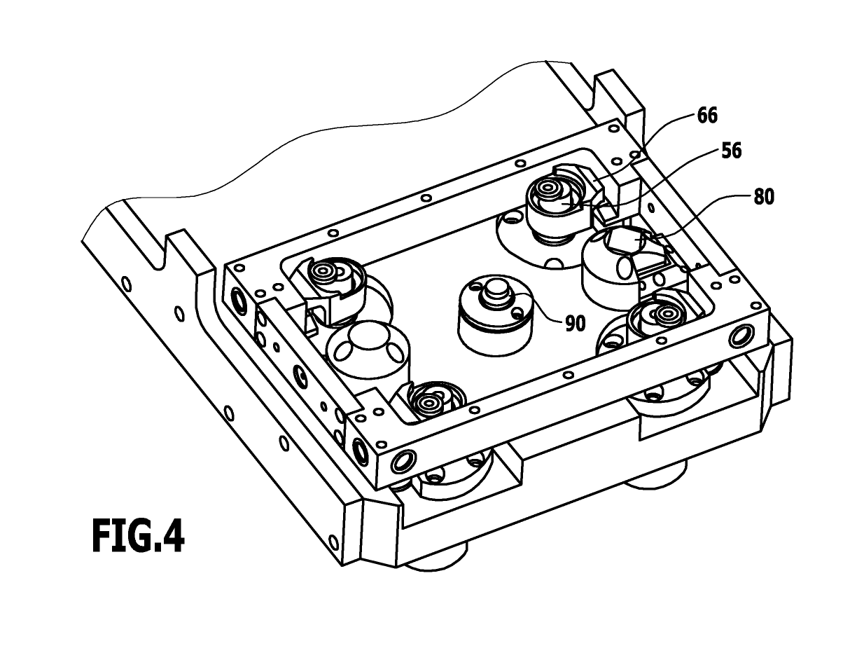

A receptacle 54 comprises a retention bar 60. Such a retention bar 60 is arranged in a corner region 58, on the wall 26. It has a blocking face 62 which is spaced apart from the rear side 46 of the holding plate 22 in the area of the corresponding receptacle 54. An interspace 64 is thereby formed between the blocking face 62 of the retention bar 60 and the rear side 46 of the holding plate 22 into which a corresponding engaging element 66 (cf. FIG. 4) of a pivoting clamp 56 can enter.

The wall 26 comprises opposing longitudinal walls 68a, 68b and opposing transverse walls 70a, 70b interposed between the longitudinal walls 68a, 68b.

In particular, the longitudinal walls 68a, 68b as well as the transverse walls 70a, 70b are provided with guide surfaces. The workpiece adapter apparatus 14 can thereby be guided and transported in different orientations.

For example, a retention bar 60 is arranged parallel to a transverse wall 70a or 70b and has an entry opening 72 that accepts entry of the corresponding engaging element 66. By way of example, the entry opening 72 is arranged forwardly of a corresponding transverse wall 70a or 70b.

In an exemplary embodiment, the holding plate 22 is provided on the rear side 46 thereof with a reinforcement area 74 which increases the stiffness of the holding plate 22, in particular in the area of the receptacles 54.

In an exemplary embodiment, the support elements 32 (and in particular also the centering elements 34) are arranged in opposing relation to the reinforcement area 74.

The support elements 32 and the centering elements 34 are mounted to the holding body 16 and secured thereto for example by screws via the reinforcement area 74.

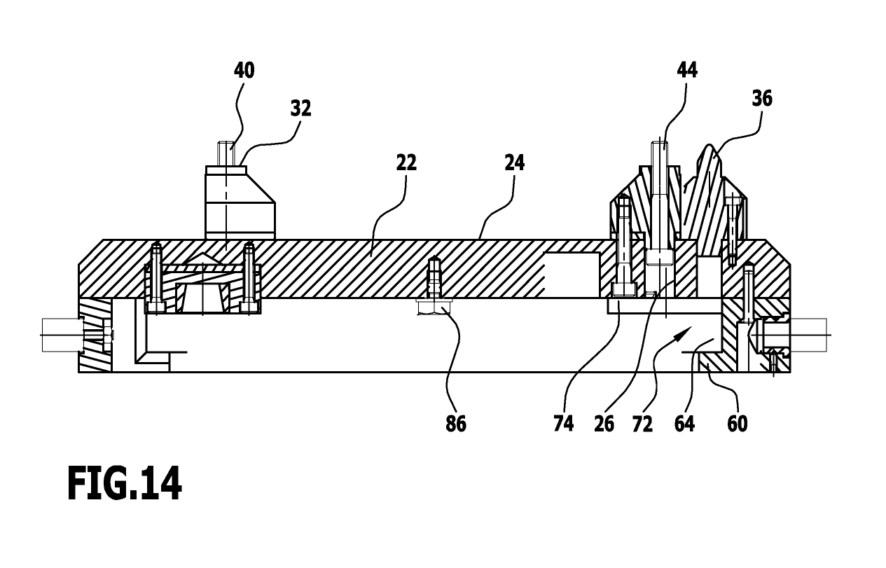

Formed between the second side 20 and the first side 18 of the holding body 16 are recesses 76 extending through the holding plate 22. The corresponding recesses 76, which are located in the reinforcement area 74 in particular, allow passage of respective form-locking elements 44 therethrough for fixing a workpiece 30 (cf. FIG. 14).

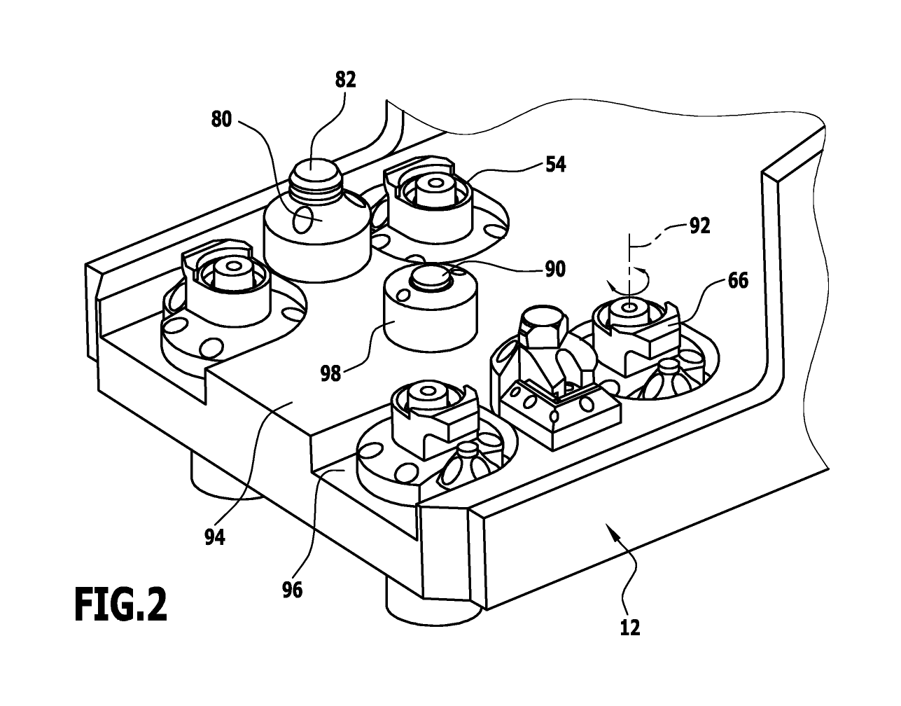

The second fixing device 52 further comprises receptacles 78 for centering elements 80 of the workpiece holding apparatus 12 (FIGS. 2 to 4).

In the exemplary embodiment as illustrated, two spaced receptacles 78 are provided.

In particular, the one or more receptacles 78 are arranged in the reinforcement area 74 and formed therein by corresponding openings.

In an embodiment, the one or more receptacles 78 are located on the holding plate 22, between the longitudinal walls 68a, 68b and the transverse walls 70a, 70b.

Provision may be made for the one or more receptacles 78 to be arranged symmetrically with respect to the longitudinal walls 68a, 68b and to be arranged symmetrically with respect to the transverse walls 70a, 70b.

In an illustrated embodiment, the receptacles 78 are located centrally between the longitudinal walls 68a, 68b. As a result, they are located between opposing receptacles 54 with respect to a transverse direction as the direction of the distance between the longitudinal walls 68a, 68b.

Furthermore, the receptacles 78 are located between receptacles 54 with respect to a longitudinal direction as the direction of the distance between the transverse walls 70a, 70b.

In an exemplary embodiment (FIGS. 6 to 8), a bolt 82 is provided as the centering element 80. Correspondingly, the receptacle 78 is formed as a centering recess for such a bolt 82.

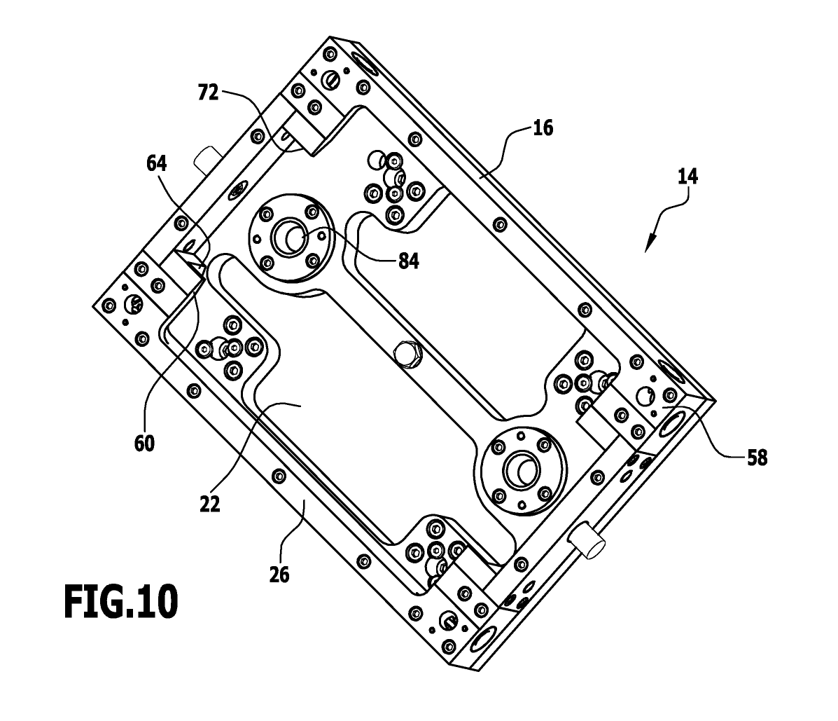

For example, it is also possible, for a centering element 80 to be configured as a cone and for a corresponding centering recess 84 (FIGS. 10 to 14) to be formed as a sleeve for the corresponding cone element. Otherwise, the configuration of the workpiece adapter apparatus of FIGS. 10 to 13 is identical to that of the workpiece adapter apparatus of FIGS. 6 to 9, and like reference symbols denote like elements.

In an exemplary embodiment, an element 86 of a detector device 88 is arranged on the second side of the workpiece adapter apparatus 14.

A cooperating mate of the detector device 88, and in particular a sensor 90, is arranged on the workpiece holding apparatus 12.

In an exemplary embodiment, the element 86 is arranged between spaced receptacles 78 in the reinforcement area 74.

For example, the element 86 is configured as an identification device in the form of a corresponding data chip.

The workpiece holding apparatus 12 (FIGS. 1 to 4) comprises a plurality of pivoting clamps 56. A corresponding pivoting clamp 56 comprises an engaging element 66 that is pivotable about an axis 92. Such an engaging element 66 is capable of being entered into the interspace 64 of the holding body 16. A fixing (clamping) action is thereby achieved.

In an exemplary embodiment (FIGS. 2 to 4), four pivoting clamps 56 are provided in a manner adapted to the workpiece adapter apparatus 14.

The pivot axis 92 is oriented transversely, and in particular perpendicularly, to the surface 24 when the workpiece adapter apparatus 14 is fixed to the workpiece holding apparatus 12.

The pivoting clamps 56 are located at vertices of a rectangle or square with respect to the axes 92 thereof.

By way of example, it is also possible to provide only two pivoting clamps 56.

In an exemplary embodiment, the workpiece holding apparatus 12 comprises a face 94 which, when the workpiece adapter apparatus 14 is fixed in place thereto, faces towards the second side 20 of the workpiece adapter apparatus 14. The pivoting clamps 56 are partially arranged in recesses 96 that are recessed with respect to said face 94.

Furthermore, centering elements 80 are arranged between such pivoting clamps 56 in a manner adapted to the receptacles 78.

Arranged between the centering elements 80 is a cooperating mate of the sensor/transmitter device 88, in particular a sensor 90.

The sensor 90 is for example located on a column 98 which is dimensioned such that when the workpiece adapter apparatus 14 and the workpiece holding apparatus 12 are correctly positioned, a corresponding sensor signal is given.

The workpiece holding apparatus 12 including the workpiece adapter apparatus 14 works as follows:

In the workpiece adapter apparatus 14, the second fixing device 52 is arranged on the second side 20 of the holding body 16 and is therefore, in a sense, arranged on the rear side of the holding body 16. Towards the first side 18, the second fixing device 52 is covered by the holding plate 22. Laterally, the second fixing device 52 is covered by the wall 26.

The workpiece adapter apparatus 14 (with the workpiece 30 fixed in position) is placed upon the workpiece holding apparatus 12 from above. In this operation, the workpiece holding apparatus 12 may be in horizontal or vertical orientation or in any intermediate position between vertical and horizontal.

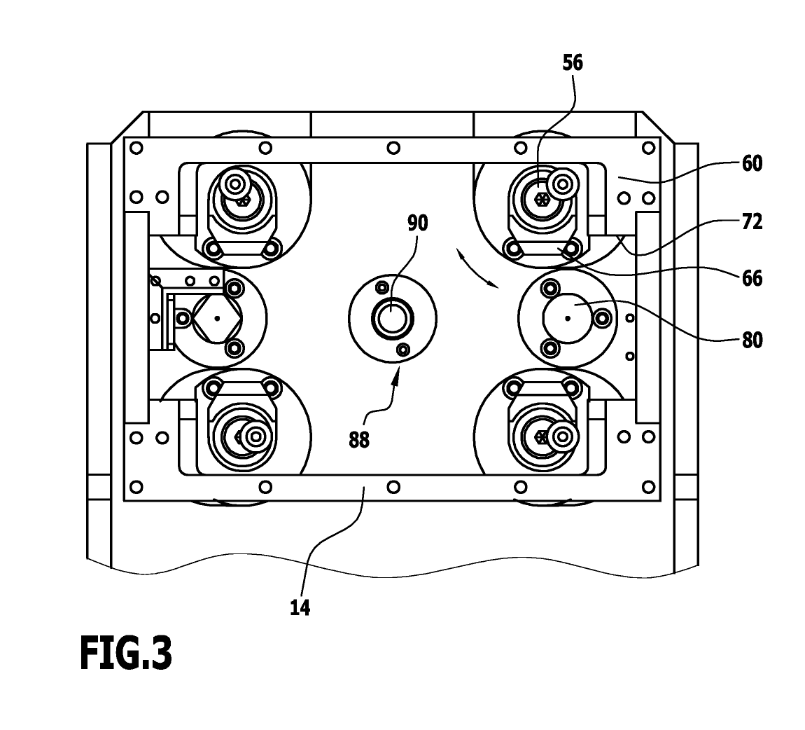

The workpiece adapter apparatus 14 is placed with its receptacles 78 on the corresponding centering elements 80, by which a corresponding positioning is provided. In the placement operation, the pivoting clamps 56 are in a non-engagement position thereof, this being depicted in FIG. 3.

In this operation, the workpiece adapter apparatus 14 is supported at least on the centering elements 80.

The pivoting clamps 56 are then turned about the pivot axes 92 thereof until the respective engaging elements 66 thereof have entered the corresponding interspaces 64 between the blocking faces 62 and the rear side 46 of the holding plate 22. This is illustrated in FIG. 4. Clamping of the workpiece adapter apparatus 14 to the workpiece holding apparatus 12 is thereby achieved.

A fixing position of the workpiece adapter apparatus 14, and therefore of the workpiece 30, on the workpiece holding apparatus 12 has then been effected. The workpiece adapter apparatus 14 is checked for correct position and orientation on the workpiece holding apparatus 12 using, for example, pneumatic support detection.

After completion of the workpiece working operation, the fixing action can be released by a corresponding pivoting action of the pivoting clamps 56 in the counter-direction, and the workpiece adapter device 14 including the workpiece fixed in place thereon can be removed.

Provided on the holding body 16, in particular on the wall 26, are engagement devices 100, such as threaded recesses or the like, with which the workpiece adapter apparatus 14 is engageable, for example for purposes of its transportation.

It is also possible for the holding body 16, and for the holding plate 22 in particular, to be provided with one or more through-recesses 102 (cf. FIG. 6) which extend between the second side 20 and the first side 18, in order to enable access to the first side 18, for example to a fluid transport system or the like, from below (from the second side 20).

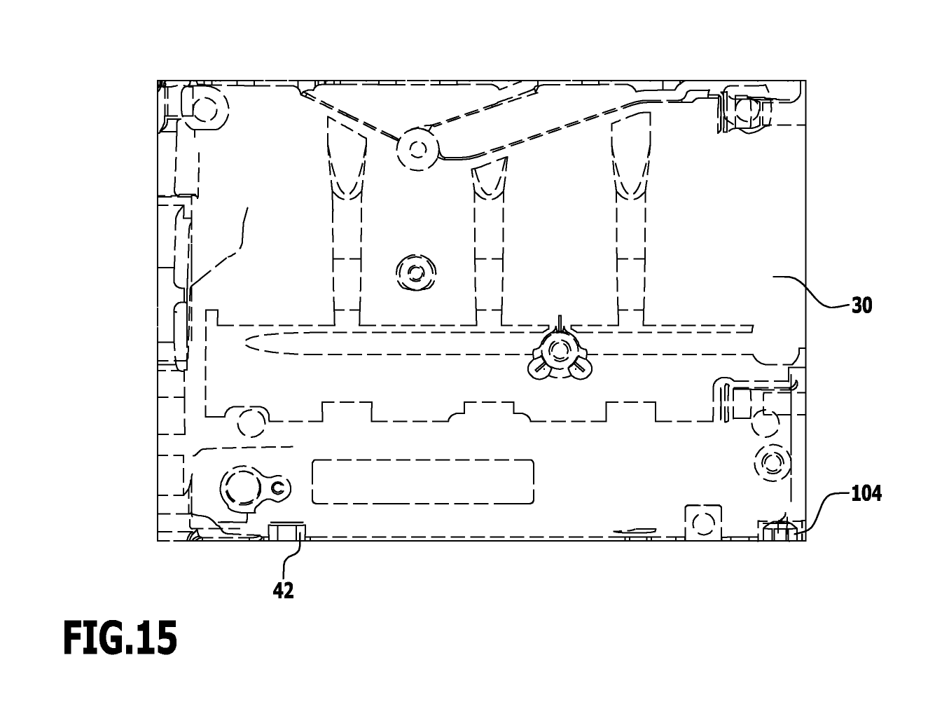

The workpiece 30 is fixed to the workpiece adapter apparatus 14. By way of example, the workpiece 30 (cf. FIG. 15) has provided thereon one or more recesses 104 into which the corresponding centering pins 36 of centering elements 34 can enter.

The workpiece adapter apparatus 14 and the workpiece 30 can be connected together in form-locking engagement by way of internal threads 42.

In the workpiece adapter apparatus 14, when it is arranged in the workpiece holding apparatus 12, corresponding fixing elements of the workpiece holding apparatus 12 as well as the second fixing device 52 are covered and do not obstruct the performance of working operations on a workpiece with a tool. The workpiece can be worked upon by the machine tool 10 from five sides.

Furthermore, the workpiece adapter device 14 can be fixed to and released from the workpiece holding device 12 in a simple manner.

The workpiece adapter apparatus 14 is easy to manufacture, whereby the machine tool 10 is also capable of being loaded and unloaded quickly.

In particular, loading and unloading the machine tool 10 with the workpiece adapter apparatus 14 requires no threading operations or the like because the workpiece adapter apparatus 14 can be placed upon the workpiece holding apparatus 12 in a direction towards the workpiece holding device 12 and can be removed from the workpiece holding apparatus 12 in the counter-direction thereto.

Furthermore, access to the workpiece 30 can be realized from below, through the holding plate 22, whereby other testing or working operations can be carried out on the workpiece 30. By way of example, tightness testing can thereby be performed.

Positioning of the workpiece adapter apparatus on the workpiece holding apparatus 12 can be achieved via the centering elements 80. In one exemplary embodiment, the centering elements 80 are, in particular, fixed bolts 82. By way of example, a fully centering bolt 82 and a partially centering bolt 82 are provided.

In an alternative exemplary embodiment, cone elements with adapted sleeves are provided for centering and positioning purposes.

The workpiece adapter apparatus 14 can have arranged thereon a data carrier of an identification device for identification purposes or the like.

### REFERENCE SYMBOL LIST

10 machine tool
12 workpiece holding device
14 workpiece adapter device
16 holding body
18 first side
20 second side
22 holding plate
24 surface
26 wall
28 first fixing device
30 workpiece
32 support element
34 centering element
36 centering pin
38 recess
40 form-locking device
42 internal thread
44 form-locking element
46 rear side
48 recessed space
50 end face
52 second fixing device
54 receptacle
56 pivoting clamp
58 corner region
60 retention bar
62 blocking face
64 interspace
66 engaging element
68a longitudinal wall
68b longitudinal wall
70a transverse wall
70b transverse wall
72 entry opening
74 reinforcement area
76 recess
78 receptacle
80 centering element
82 bolt
84 centering recess
86 element
88 detector device
90 sensor
92 pivot axis
94 face
96 recess
98 column
100 engagement device
102 recess
104 recess

What is claimed is:

1. Workpiece adapter apparatus for a machine tool to which at least one workpiece is fixable and which is fixable to a workpiece holding apparatus of the machine tool, comprising a holding body having a first side on which is arranged a first fixing device for the at least one workpiece and having a second side, opposite the first side, on which is arranged a second fixing device for fixing the holding body to the workpiece holding apparatus.

2. Workpiece adapter apparatus in accordance with claim 1, wherein the holding body is at least approximately cuboid in shape.

3. Workpiece adapter apparatus in accordance with claim 1, wherein the holding body has a holding plate on which the first fixing device is arranged.

4. Workpiece adapter apparatus in accordance with claim 3, wherein the holding plate is of at least approximately planar configuration on the first side.

5. Workpiece adapter apparatus in accordance with claim 3, wherein the holding plate covers the second fixing device towards the first side.

6. Workpiece adapter apparatus in accordance with claim 3, wherein the holding plate has a wall arranged thereon on the side facing away from the first side, which wall is in particular located at the edge of the holding plate and in particular extends around the perimeter thereof.

7. Workpiece adapter apparatus in accordance with claim 6, wherein the second fixing device is arranged on at least one of the holding plate and the wall.

8. Workpiece adapter apparatus in accordance with claim 3, wherein the wall covers the second fixing device laterally.

9. Workpiece adapter apparatus in accordance with claim 6, wherein a recessed space is formed between a rear side of the holding plate, facing away from the first side, and the wall.

10. Workpiece adapter apparatus in accordance with claim 6, wherein an end face of the wall is configured as a guide surface.

11. Workpiece adapter apparatus in accordance with claim 1, wherein the second fixing device has receptacles for at least one of entry elements and engaging elements of the workpiece holding apparatus.

12. Workpiece adapter apparatus in accordance with claim 11, wherein receptacles of the second fixing device are arranged in corner regions of the holding body.

13. Workpiece adapter apparatus in accordance with claim 11, wherein at least four receptacles are provided, wherein at least two receptacles are provided for centering and at least two receptacles are provided for clamping.

14. Workpiece adapter apparatus in accordance with claim 11, wherein at least one receptacle for centering is arranged between receptacles for clamping.

15. Workpiece adapter apparatus in accordance with claim 1, wherein the holding body has arranged thereon retention bars of the second fixing device for engagement therein of respective pivoting clamps of the workpiece holding apparatus.

16. Workpiece adapter apparatus in accordance with claim 15, wherein at least two retention bars are provided.

17. Workpiece adapter apparatus in accordance with claim 15, wherein a retention bar has a blocking face which is spaced apart from a rear side, opposite the first side, of a holding plate.

18. Workpiece adapter apparatus in accordance with claim 1, wherein the holding body has arranged thereon at least two centering recesses of the second fixing device for a respective centering element of the workpiece holding apparatus.

19. Workpiece adapter apparatus in accordance with claim 18, wherein the at least one centering recess is configured for receiving a bolt or in the form of a sleeve for a cone element.

20. Workpiece adapter apparatus in accordance with claim 1, wherein a transmitter or a sensor or an identification device is arranged on the second side of the holding body.

21. Workpiece adapter apparatus in accordance with claim 1, wherein the holding body comprises at least one through-recess via which communication between the second side and the first side is established.

22. Workpiece adapter apparatus in accordance with claim 1, wherein the first fixing device has support elements for the at least one workpiece.

23. Workpiece adapter apparatus in accordance with claim 1, wherein the first fixing device has a form-locking device for form-locking fixing of the at least one workpiece to the holding body.

24. Combination of a workpiece holding apparatus and a workpiece adapter apparatus, comprising
a workpiece holding apparatus arranged on the machine tool and at least one workpiece adapter apparatus;
said workpiece adapter apparatus comprising a holding body having a first side on which is arranged a first fixing device for the at least one workpiece and having a second side, opposite the first side, on which is arranged a second fixing device for fixing the holding body to the workpiece holding apparatus, wherein the workpiece adapter apparatus is releasably fixed or fixable to the workpiece holding apparatus via fixing elements of the workpiece holding apparatus.

25. Combination of a workpiece holding apparatus and a workpiece adapter apparatus in accordance with claim 24, wherein the workpiece holding apparatus comprises as the fixing element a plurality of pivoting clamps.

26. Combination of a workpiece holding apparatus and a workpiece adapter apparatus in accordance with claim 24, wherein the workpiece holding apparatus comprises as the fixing elements at least two centering elements for entering a respective receptacle of the workpiece adapter apparatus.

27. Combination of a workpiece holding apparatus and a workpiece adapter apparatus in accordance with claim 26, wherein a centering element is a centering bolt or a centering cone.

28. Combination of a workpiece holding apparatus and a workpiece adapter apparatus in accordance with claim 24, wherein the workpiece holding apparatus comprises a sensor, wherein a cooperating mate is arranged on the workpiece adapter apparatus.

29. Combination of a workpiece holding apparatus and a workpiece adapter apparatus in accordance with claim 24, wherein, when the workpiece adapter apparatus is fixed to the workpiece holding apparatus, the workpiece adapter apparatus covers fixing elements of the workpiece holding apparatus towards the first side.

30. Machine tool, comprising a combination of a workpiece holding apparatus and a workpiece adapter apparatus;
said combination comprising
a workpiece holding apparatus arranged on the machine tool; and
at least one workpiece adapter apparatus;
said workpiece adapter apparatus comprising a holding body having a first side on which is arranged a first fixing device for the at least one workpiece and having a second side, opposite the first side, on which is arranged a second fixing device for fixing the holding body to the workpiece holding apparatus;
wherein the workpiece adapter apparatus is releasably fixed or fixable to the workpiece holding apparatus via fixing elements of the workpiece holding apparatus.
